(19) United States
(12) Patent Application Publication
(10) Pub. No.: US 2018/0235192 A1
(43) Pub. Date: Aug. 23, 2018

(54) Aquatic Artificial Habitat

(71) Applicant: Brad Franklin Metzler, Gainesville, TX (US)

(72) Inventor: Brad Franklin Metzler, Gainesville, TX (US)

(21) Appl. No.: 15/440,067

(22) Filed: Feb. 23, 2017

(51) Int. Cl. A01K 61/10

(52) U.S. Cl. CPC A01K 61/10

(57) ABSTRACT

An artificial habitat for a variety of aquatic taxa, including fish, which provides dynamic habitat consisting of buoyant, corrugated high or low density polyethylene pipe split longitudinally as to form two or more strips of ribbed material that curls to mimic aquatic plant genera such as Vallisneria.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

Habitat is an essential component of aquatic environments necessary to support biological processes and ecological interactions for a multitude of organisms from a variety of taxa. Many freshwater sport fish species, particularly fishes within the families Centrarchidae, Moronidae, and Percidae, require habitat throughout life histories stages from early development to full maturity. For these species, and others, life processes such as feeding, reproduction, and survival are facilitated by and are, at times, dependent upon the occurrence of habitat. Aquatic plants, detrital cover, woody debris, and in-organic sediment based compositions such as bed-rock, gravel, cobble; or the multitude of features that are formed and found within freshwater environments function as habitat. However, naturally occurring habitat in reservoirs and lake systems degrade over time providing little to no functional benefit to aquatic sport fish species and other taxa. As such, artificial fish habitat is a human-made alternative to supplement naturally occurring habitat in various forms. Artificial fish habitat has been created previously that includes internal shelter spaces for a variety of taxa, mainly fish, and others that are designed to attract fish.

Current and past arts of artificial habitat are predominantly static and unnatural in appearance. In particular, no previous art mimics the natural form and relative function to that of submergent plant species such as Vallisneria, a ubiquitous and highly valued plant species often promoted in fisheries communities, in one way or another, for use as vegetation that encourages systemic productivity. Additionally, previous art of artificial fish habitat does not utilize a material that is altogether: corrugated, buoyant, curls to resemble submerged macrophytes, is capable of wave-induced natural movement, and has an increased ratio of available surface area to relative size for valuable periphyton growth. Attributes described specific to the proposed invention relate not only to fish habitat, but as well as habitat for aquatic organisms such as macroinvertebrates.

The art of artificial fish habitat is diverse and is known with various features specific to fish movement and utilization. Few arts are previously described among artificial fish habitat as having resembled naturally occurring submerged plants. U.S. Pat. No. 4,727,672 to Loren et al. (hereafter referred to as Loren et al.) describes a series of plastic, extended, leaf-like fronds attached to a trunk assembly with ballast for submersion wherein the habitat, once sunk, provides cover similar to that of aquatic flora. Loren et al. teaches a circumferentially preselected array for placement of predominantly broad shaped leaf-like fronds. The present invention improves on the concept due to the structural characteristics and complexity of the habitat, which, when submerged, thoroughly resembles the forms of a more ubiquitous and natural submerged aquatic vegetation form present in the genera Vallisneria, which has an entirely different structural layout than that which Loren et al. teaches.

Several arts are described among artificial fish habitat consisting of internal shelter spaces. U.S. Pat. No. 5,201,136 to LaMorte et al. describes a hollow, tube-like fish habitat for use in an aquatic environment made from polyethylene that forms sidewalls containing a multitude of rectangular openings to provide fish access to internal shelter. U.S. Pat. No. 8,020,515 to Metzler describes a cone or dome shaped body made from a similar material comprising a wall portion forming an interior chamber with apertures for passing water there through and multiple chamfered openings that allow limbs to be frictionally fit and slotted into place so that the body supports the protruding limbs. Although others are known, the above inventions exemplify the features that encompass artificial fish habitat with internal shelter spaces for fishes, of which the specific attributes of the present invention are separate and represent a novel approach to artificial habitat for use in lentic aquatic ecosystems.

Several arts are known among artificial fish habitat that do not directly reference internal shelter space as a prime claim, but do include buoyant material as specific claim. U.S. Pat. No. 4,441,453 to McMickle et al. (hereafter referred to as McMickle et al.) describes an artificial fish habitat consisting of individual strands of buoyant material either made of foamed polyolefin, hollow filaments of polytetrafluoroethylene, blown polyethylene, polypropylene, nylon, urethane, or vinyl, cut at varying lengths and attached to a flat bottom die cast zinc weight for placement in freshwater ecosystems such as lakes. Buoyancy is a specific claim to McMickle et al., though the specific material of the proposed invention including corrugation and structurally induced curling, are not. Therefore, the proposed invention is novel and represents an improvement to the teachings of McMickle et al. that was not obvious at the time.

Of artificial habitat that is moored to a plurality of weights and tethered to a buoyant float assembly as to be suspended above the substrate, or combination of substrates, contained at the bottom of an aquatic or marine environment, several are known. U.S. Pat. No. 5,884,585 to Streichenberger (hereafter referred to as Streichenberger) teaches a fence-like habitat for sheltering and feeding fish composed of long, linear and flexible substrates that are moored to a weight and tethered as to be arranged vertically relative to a buoyant assembly which suspends the system and allows the substrates to move independently by water movement. Further, U.S. Pat. No. 7,828,493 to Brignac (hereafter referred to as Brignac) teaches an artificial reef composed of a plurality of buoyant rod-like bodies positioned as to protrude distally from a rotatable mounted axle rod attached to center axle wherein two cables are tethered to weights which keep the reef suspended at a specific depth. Streichenberger teaches an artificial habitat that is linear with no mention of the ability of the material to appear organic or natural in form, or to physically curl to mimic natural aquatic plant species. Brignac teaches an artificial reef which is suspended and capable of independent rotation of reef bodies around an axle rod, which is a separate concept to that of the proposed invention which does not encompass or claim to have rotation as a component or a part of the primary features producing dynamic process for use as aquatic artificial habitat.

U.S. Pat. No. 8,640,651 to Ewald (hereafter referred to as Ewald) describes a sinkable container with one open end from which a plurality of elongated and substantially flat reclaimed vinyl projections may be inserted and adhered together within the container using cement. Ewald claims specific to elongated and flat reclaimed vinyl projections are that they may be twisted from 10 to 100 degrees prior to placement. Corrugation and buoyancy are not specific claims to Ewald.

In its totality, the invention provides amenities beyond that of prior arts. Corrugation of buoyant material to impart inherent structurally induced curling as to portray a physical organic appearance similar to that of submerged macrophytes is not claimed as a unique feature to the functionality of the inventions encompassing previous arts of artificial fish habitat. Corrugation of buoyant material to impart structurally induced curling similar to that of submerged macrophytes is an improvement to artificial fish habitat using buoyant materials. Artificial habitat for use in aquatic ecosystems for a variety of taxa, not just fish, should include features relative to the life cycle of such taxa. As such, the proposed invention includes corrugation as a benefit to aquatic taxa such as macroinvertebrates by providing spaces between the corrugation as attachment points for larval silk spinning families within orders Trichoptera, Lepidoptera, Diptera, and others. Additionally, and inherent to the proposed invention, is the large surface area to relative size ratio intrinsic to corrugation of buoyant materials sunk in lentic aquatic environments for growth of periphyton. A larger surface area for periphyton, which provides a food resource for a variety of aquatic based taxa, is an additional benefit of the invention as aquatic habitat.

### BRIEF SUMMARY OF THE INVENTION

The invention comprises use of singular or multiple units composed of buoyant, corrugated plastic tubing such as high or low density polyethylene pipe, cut longitudinally as to create two or more uniform strips of corrugated plastic connected by an uncut tubular base segment to be attached by fasteners to a plurality of weighted bases or sections of corrugated plastic pipe as to create a system, or systems, and then sunk in lentic aquatic ecosystems, mainly lakes, for the purpose of creating artificial habitat for a variety of aquatic taxa, including fish. The strips of corrugated plastic are buoyant and will therefore float in water providing vertical cover with a ribbed texture, once weighted. The strips curl in various degree due to the corrugation applying tension and force on the material as to render further manipulation of the strips to impart curling to form shape once placed into the water, unnecessary. The curling provides an unpredictable and organic appearance to the structural complexity of the artificial habitat once placed for use in lentic aquatic ecosystems. The inherent flexibility of the strips radiating out from a base or array move dynamically with water turbulence created by wave induced current.

The present invention utilizing corrugated strips of high or low-density polyethylene material, once submerged, will curl to create a biological appearance similar to that of the structural complexity of macrophytes, particularly the genera of Vallisneria. The structural similarities of the present invention to that of Vallisneria allows this artificial habitat to be used as a supplement to naturally occurring aquatic vegetation during seasonal periods of reduced growth and as replacement of naturally occurring aquatic vegetation in reservoirs where vegetation notoriously occurs at lower frequency. The ability to suspend the buoyant material is intrinsic to the value of the invention for use in aquatic systems where water levels fluctuate seasonally from a combination of both natural and anthropogenic factors.

### BRIEF DESCRIPTION OF THE DRAWINGS

FIG. 1 is a sectional view of the face of a corrugated strip resulting from cutting high- or low-density polyethylene pipe longitudinally;

FIG. 2 is a partial sectional view of corrugated strips terminating into the base of a high or low density polyethylene pipe;

FIG. 3 illustrates a typical embodiment of the present invention where buoyant strips terminate into a base that is attached to a weight and then submerged in a lentic aquatic environment;

FIG. 4 shows a cross section view of an alternative attachment of strips terminating into a base that is fastened to an additional corrugated pipe;

FIG. 5. is a view of another means of frictional fit of one corrugated pipe through another corrugated pipe by means of a cut and bending;

FIG. 6. illustrates an additional embodiment of the present invention where arms of the habitat radiate outwardly from a central spoke, or aluminum hub, that is then suspended at depth in lentic aquatic environment.

### DETAILED DESCRIPTION OF THE INVENTION

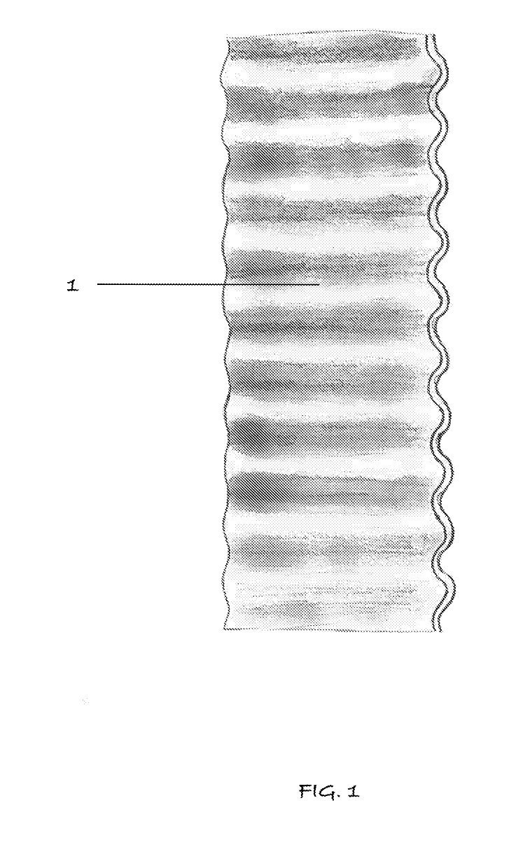

The present invention utilizes buoyant strips 1 of corrugated material, as shown in FIG. 1, for use as artificial habitat where the alternating grooves and ridges are formed from cutting corrugated pipe longitudinally as to split it into two or more sections. Width of buoyant strips 1 range from 0.75 to 3.0 inches and length of buoyant strips 1 range from 12.0 to 120.0 inches. These strips can be cut from high or low density polyethylene pipe wherein corrugation is distributed evenly throughout the length of the material.

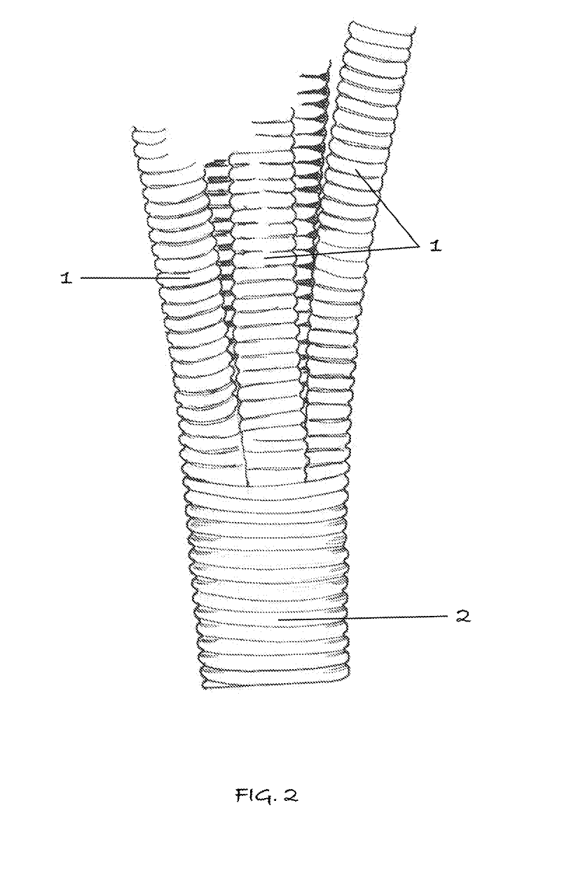

FIG. 2 shows the buoyant strip 1 connected to an uncut corrugated pipe base 2 to create a whirled pattern composed at a minimum of two buoyant strips 1 and a maximum of twenty buoyant strips 1. The diameter of the corrugated pipe base 2 ranges from 1.0 to 5.0 inches. Means of attachment between buoyant strips 1 as it connects to the corrugated pipe base 2 is provided by precise and uniform termination of tooling 3 as to not split the corrugated pipe fully.

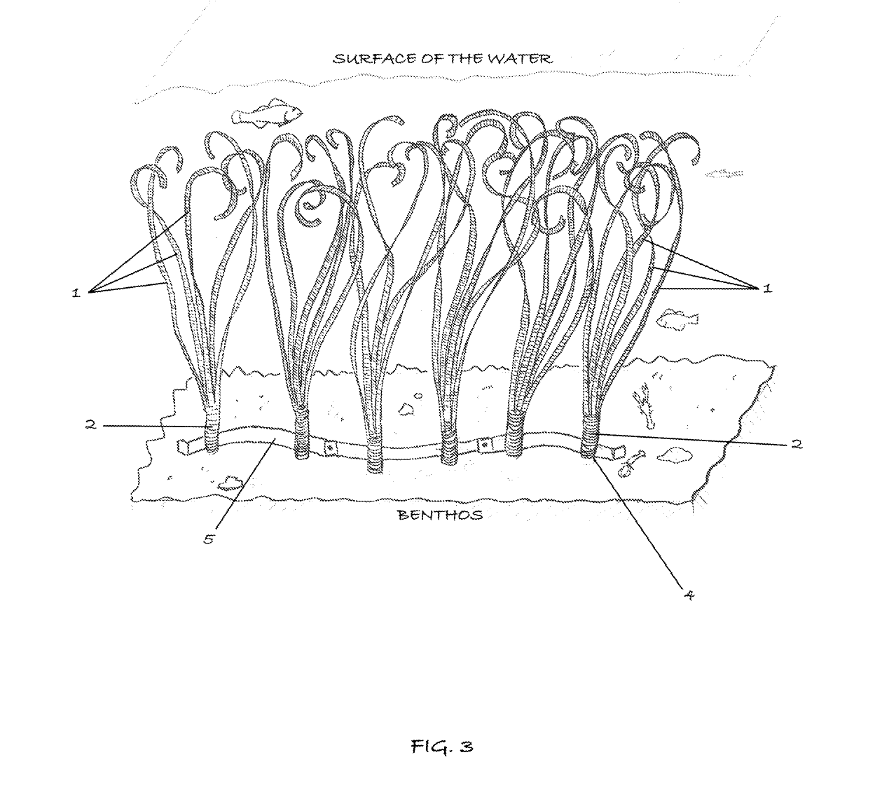

Examples of typical embodiments of the invention are groups of one, or more, units of corrugated plastic pipe cut longitudinally to form two or more buoyant, flexible strips in lengths ranging from 2 to 10 ft that connect to an uncut corrugated plastic pipe base that is fastened to a chemically resistant weight to be submerged as artificial habitat in lentic aquatic ecosystems as in FIG. 3. Buoyant strips 1 connected to uncut corrugated bases 2 forming a unit, are arranged and fastened 4 uniformly to a chemically resistant weight 5 as to allow vertical placement to that of the horizontal plane of the benthos when submerged in an aquatic environment.

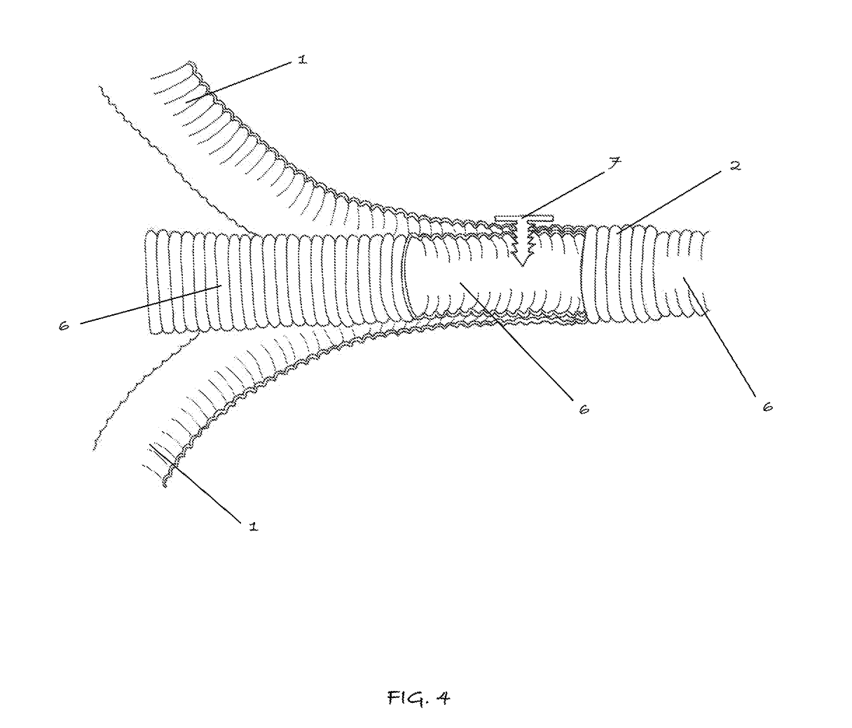

FIG. 4 demonstrates an alternative means of attaching corrugated strips 1 connected to a base 2, shown as a cross section of corrugated pipe 6 wherein whirled buoyant strips 1 connected to base 2 with a singular cut are then fastened 7 to a section of corrugated pipe 6.

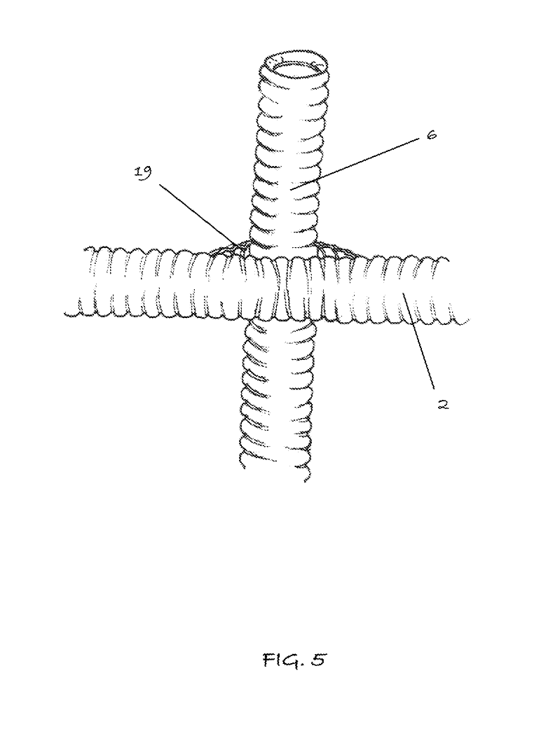

FIG. 5 yet further illustrates another arrangement of base 2 that is frictionally fit to a section of uncut corrugated pipe 6. The base 2 is slit horizontally as to allow another corrugated pipe 6 to be inserted into space 19 created by the slits as to lock into position and hold the base 2 containing whirled buoyant strips in a horizontal position to that of the benthos. Sections of uncut corrugated pipe may be utilized as attachment points for buoyant strip 1 and uncut base 2 units in either a frictionally fit horizontal position or attached via a fastener as shown in FIG. 4.

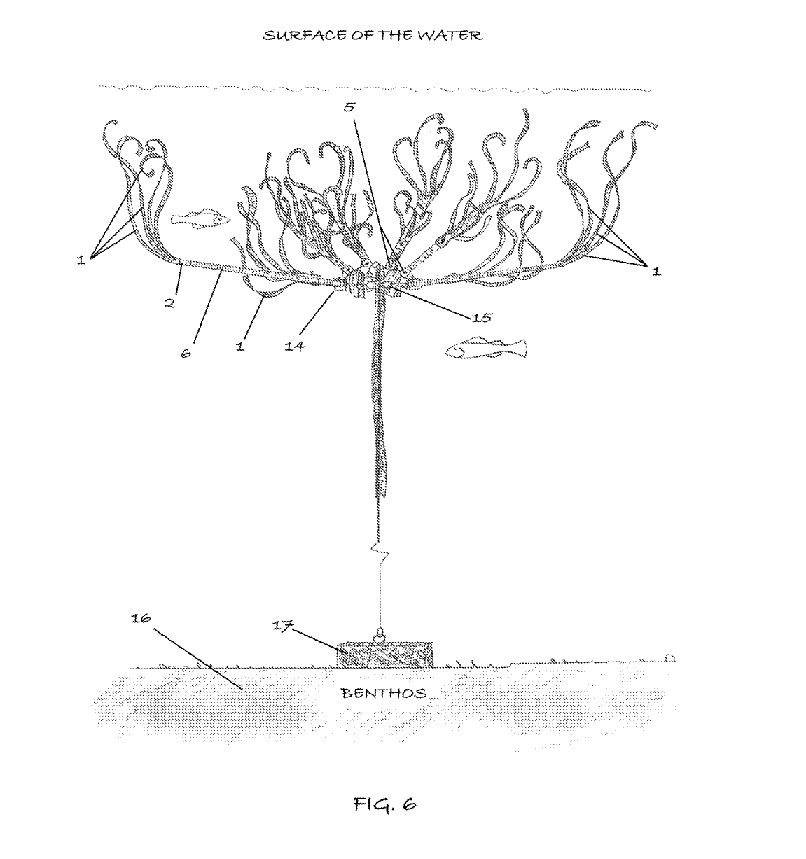

An additional example of embodiment of the invention are groups of one, or more, units of corrugated plastic pipe cut longitudinally to form two or more buoyant, flexible strips 1 in lengths ranging from two to twelve feet that connect via fasteners to a hub 15 and arranged in an outwardly facing polar array as to form a spoke to extend the units in a horizontal plane to that of the benthos as in FIG. 6. The buoyant strips 1 connected to a base 2 with a singular cut as to allow coupling and then fastening over a uncut corrugated base 6 shown in FIG. 4 are utilized in a spoke style setting where five or more elongated bases 6 with both buoyant strips 1 with greater than one couple base 6 and associated strips are arranged in an outwardly facing polar array 14 connected to a further buoyant hub 15 via fasteners 5 as to form a spoke to extend in a horizontal plane to that of the benthos, which may be suspended at specific depth vertical from a plurality of weights 17 to that of the benthos 16.

A further example of a typical embodiment of the invention shown in FIG. 5, are groups of one, or more, units of corrugated plastic pipe cut longitudinally to form two or more buoyant, flexible strips 1 in lengths ranging from 2 to 10 ft that connect to an uncut corrugated plastic pipe base 2 that is slit as to couple onto an additional uncut corrugated plastic pipe and attached by a fastener so that the strips radiate outwardly from the uncut corrugated plastic pipe forming a whirl of strips. The embodiments described represent the principal arrangements of the invention but should not be limited by the designated examples and therefore possible combinations inclusive to the design of corrugated, flexible, buoyant plastic material will include all methods, embodiments, and variations thereof for use in artificial fish habitat.

The habitat can be positioned at a variety of depths with the preferred placement where all components of the system are under, or just breaking through, the surface of the water as shown in FIGS. 3 and 6. The corrugated strips can be arranged individually; grouped together in one or more bound units or attached horizontally radiating out from an uncut corrugated pipe that is vertically arranged as in FIG. 6. Length of strips of corrugated pipe can range from 2 feet to 10 feet and width range from 0.5 to 3 inches.

What is claimed is:

1. Artificial habitat for use in lentic aquatic ecosystems for a variety of taxa including fish, comprising:
two or more buoyant, flexible, corrugated strips of high or low density polyethylene, cut from corrugated high or low density polyethylene pipe, having a length between 2 and 15 feet and a width between 1 and 4 inches, connected to a base of corrugated pipe as to form a single continuous unit.

2. A fastening system where the artificial habitat of claim 1 can be frictionally held in place or bolted, as to attach one or more to a length of high or low density corrugated pipe.

3. The artificial habitat of claim 1 where a fastening system is used to attach two or more of the units in groups up to 100 to a plurality of weights made from chemically resistant metal.

4. The artificial habitat of claim 1 where it is arranged in a spoke style array from an aluminum central hub.

5. The habitat of claim 1 radiates outwardly from the arrange of claim 4 to form an organic and unpredictable appearance.

6. The habitat formed by claims 4 and 5 wherein it is suspended at a specific depth to that of the benthos.

7. The artificial habitat of claim 1 wherein, once submerged in a lentic aquatic ecosystem:
curls to create a biological appearance similar to that of the structural complexity of macrophytes, particularly Vallisneria and similar species;
the corrugation provides an increase in surface area for growth of valuable periphyton relative to overall size of the habitat;
and that movement induced by turbulence from wave driven currents provides a dynamic habitat similar to that of the movement of submergent aquatic vegetation.
